(19) United States
(12) Patent Application Publication
(10) Pub. No.: US 2006/0225355 A1
(43) Pub. Date: Oct. 12, 2006

(54) Pneumatic motor control system

(75) Inventors: Gary L. Baczewski, Garden Ridge, TX (US); Frank Dillingham, Boerne, TX (US)

Correspondence Address: LAW OFFICES OF CHRISTOPHER L. MAKAY, 1634 Milam Building, 115 East Travis Street, San Antonio, TX, 78205, US

(73) Assignee: Gary L. Baczewski

(21) Appl. No.: 11/451,219

(22) Filed: Jun. 12, 2006

Related U.S. Application Data
(63) Continuation-in-part of application No. 10/930,658, filed on Aug. 31, 2004.

(51) Int. Cl. E05F 11/00; E05F 15/00

(52) U.S. Cl. 49/199

(57) ABSTRACT

A pneumatic motor control system includes a pilot valve in communication between a pneumatic gas source and a pneumatic motor and a pressurized check valve in communication with the pilot valve. The pilot valve normally rests in a neutral position that does not allow the passage of gas from the pneumatic gas source to the pneumatic motor. However, venting of the pressurized check valve shifts the pilot valve to a first position. In the first position, the pilot valve allows the passage of gas from the pneumatic gas source through the first pilot valve and to the pneumatic motor.

### CROSS-REFERENCE TO RELATED APPLICATION

This application is a continuation-in-part of application Ser. No. 10/930,658, which was filed Aug. 31, 2004. By this reference, the full disclosure of U.S. patent application Ser. No. 10/930,658 is incorporated herein as though now set forth in its entirety.

### BACKGROUND OF THE INVENTION

1. Field of the Invention

The present invention relates to pneumatic motors, and more particularly, but not by way of limitation, to a pneumatic motor control system.

2. Description of the Related Art

In some applications, an electric motor is preferable to a pneumatic motor because electric motors are generally more efficient. Nevertheless, there are certain applications where a pneumatic motor is more desirable. Illustratively, a pneumatic motor is more desirable in applications that require a motor stall capability because a pneumatic motor may be stalled and then restarted or reversed without the necessity of a system reset. Moreover, a pneumatic motor is more desirable in explosion proof applications where the risk of spark associated with electrical motors must be eliminated. Applications employing pneumatic motors include but are not limited to construction machinery, conveyors, hoisting equipment, mixing equipment, packaging equipment, paint/finishing equipment, printing equipment, pump drives, and fan drives.

As with any motor, a pneumatic motor requires a controller to regulate operation thereof. Example controllers are disclosed in U.S. Pat. No. 4,891,908, issued Jan. 9, 1990, to Aquilina and U.S. Pat. No. 4,417,418, issued Nov. 29, 1983, to Warning. While Aquilina and Warning disclose controllers for a pneumatic motor, those controllers however include electrical components that make them unsuitable for explosion proof applications. Another example controller is disclosed in U.S. Pat. No. 3,921,335, issued Nov. 25, 1975, to Hewitt et al. While Hewitt et al. disclose a pneumatic control scheme, that pneumatic control scheme does not include stall and reverse features. Still another example controller is disclosed in U.S. Pat. 5,937,579, issued Aug. 17, 1999, to Baczewski, et al. Baczewski, et al. disclose a pneumatic motor controller with reversing and stopping features, nevertheless, a less complicated and more cost effective design would be desirable.

Accordingly, a simple, more cost effective, and completely pneumatic control system for a pneumatic motor that includes stopping and reversing capabilities would improve over conventional pneumatic motor controllers.

### SUMMARY OF THE INVENTION

In accordance with the present invention, a pneumatic motor control system includes a first pilot valve in communication between a pneumatic gas source and a pneumatic motor and a first pressurized check valve in communication with the pilot valve. The first pilot valve normally rests in a neutral position that does not allow the passage of gas from the pneumatic gas source to the pneumatic motor. However, venting of the first pressurized check valve shifts the first pilot valve to a first position. In the first position, the first pilot valve allows the passage of gas from the pneumatic gas source through the first pilot valve and through the pneumatic motor from a first port of the pneumatic motor to a second port of the pneumatic motor. In the first position, the first pilot valve also exhausts gas leaving the second port of the pneumatic motor.

The pneumatic motor control system may include a second pressurized check valve in communication with the pilot valve. Venting of the second pressurized check valve shifts the first pilot valve to a second position. In the second position, the first pilot valve allows the passage of gas from the pneumatic gas source through the first pilot valve and through the pneumatic motor from the second port of the pneumatic motor to the first port of the pneumatic motor. In the second position, the first pilot valve also exhausts gas leaving the first port of the pneumatic motor.

The pneumatic motor control system further includes a brake gas cylinder coupled to a brake and a shuttle check valve in communication with the first and second ports of the pneumatic motor and the brake gas cylinder. The delivery of gas to the pneumatic motor opens the shuttle check valve to the brake gas cylinder, thereby extending the brake gas cylinder to release the brake.

The first pilot valve may include a biasing return that maintains the first pilot valve in the neutral position when the system is not vented. Alternatively, the pneumatic motor control system may include a second pilot valve in communication between the pneumatic gas source and first and second return gas cylinders and a pressurized check valve in communication with the second pilot valve. The second pilot valve rests in a neutral position that does not allow the passage of gas from the pneumatic gas source to the first and second return gas cylinders. However, venting of the check valve shifts the second pilot valve to a first position that allows the passage of gas from the pneumatic gas source through the second pilot valve and to the first and second return gas cylinders. Pressurizing the first and second return gas cylinders extends the first and second return gas cylinders, thereby returning the first pilot valve from either the first position or the second position to the neutral position.

The pneumatic motor control system may include a third pilot valve in communication with the first and second ports of the pneumatic motor. The third pilot valve is also in communication with either the pressurized check valve in communication with the second pilot valve or the second pressurized check valve in communication with the first pilot valve. A biasing mechanism is disposed in the third pilot valve such that, when a pressure differential between the first and second ports of the pneumatic motor overcomes the biasing force of the biasing mechanism, the third pilot valve vents the pressurized check valve in communication with the second pilot valve or the second pressurized check valve in communication with the first pilot valve. When the third pilot valve vents the pressurized check valve in communication with the second pilot valve, the second pilot valve shifts to the first position and allows the passage of gas from the pneumatic gas source through the second pilot valve and to the first and second return gas cylinders. Pressurizing the first and second return gas cylinders extends the first and second return gas cylinders, thereby returning the first pilot valve from either the first position or the second position to the neutral position. When the third pilot valve vents the second pressurized check valve in communication with the first pilot valve, the first pilot valve allows the passage of gas from the pneumatic gas source through the first pilot valve and through the pneumatic motor from the second port of the pneumatic motor to the first port of the pneumatic motor.

The pneumatic motor control system may include a fourth pilot valve in communication with the first and second ports of the pneumatic motor. The fourth pilot valve is also in communication with either the pressurized check valve in communication with the second pilot valve or the first pressurized check valve in communication with the first pilot valve. A biasing mechanism is disposed in the fourth pilot valve such that, when a pressure differential between the first and second ports of the pneumatic motor overcomes the biasing force of the biasing mechanism, the fourth pilot valve vents the pressurized check valve in communication with the second pilot valve or the first pressurized check valve in communication with the first pilot valve. When the fourth pilot valve vents the pressurized check valve in communication with the second pilot valve, the second pilot valve shifts to the first position and allows the passage of gas from the pneumatic gas source through the second pilot valve and to the first and second return gas cylinders. Pressurizing the first and second return gas cylinders extends the first and second return gas cylinders, thereby returning the first pilot valve from either the first position or the second position to the neutral position. When the fourth pilot valve vents the first pressurized check valve in communication with the first pilot valve, the first pilot valve allows the passage of gas from the pneumatic gas source through the first pilot valve and through the pneumatic motor from the first port of the pneumatic motor to the second port of the pneumatic motor.

In accordance with a method of controlling a pneumatic motor, a first pressurized check valve in communication with a first pilot valve is vented, thereby moving the first pilot valve from a neutral position to a first position. A pneumatic gas source then delivers gas through the first pilot valve and through the pneumatic motor from a first port of the pneumatic motor to a second port of the pneumatic motor. The first pilot valve exhausts gas leaving the second port of the pneumatic motor.

A second pressurized check valve in communication with the first pilot valve may be vented, thereby moving the first pilot valve from the neutral position to a second position. A pneumatic gas source then delivers gas through the first pilot valve and through the pneumatic motor from the second port of the pneumatic motor to the first port of the pneumatic motor.

The venting of the first pressurized check valve in communication with the first pilot valve may be ceased to return the first pilot valve from the first position to the neutral position. Similarly, the venting of the second pressurized check valve in communication with the first pilot valve may be ceased to return the first pilot valve from the second position to the neutral position.

Alternatively, a pressurized check valve in communication with a second pilot valve may be vented, thereby moving the second pilot valve from a neutral position to a first position. The pneumatic gas source accordingly delivers gas through the second pilot valve and to first and second return gas cylinders, thereby extending the first and second return gas cylinders to shift the first pilot valve from either the first position or the second position to the neutral position.

The pressure differential between the first and second ports of the pneumatic motor may be measured. If the pressure differential between the first and second ports of the pneumatic motor surpasses a desired level, the pressurized check valve in communication with the second pilot valve is vented, thereby moving the second pilot valve from the neutral position to the first. The pneumatic gas source accordingly delivers gas through the second pilot valve and to first and second return gas cylinders, thereby extending the first and second return gas cylinders to shift the first pilot valve from either the first position or the second position to the neutral position. Alternatively, if the pressure differential between the first and second ports of the pneumatic motor surpasses a desired level, either the first or the second pressurized check valve in communication with the first pilot valve may be vented.

It is therefore an object of the present invention to provide a completely pneumatic, simplified, and constantly pressurized pneumatic motor control system.

It is another object of the present invention to provide a pneumatic motor control system with safety stop features.

It is a further object of the present invention to provide a hold to operate pneumatic motor control system.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTIONS OF THE DRAWINGS

FIG. 1 is a block diagram illustrating the main components of a pneumatic motor control system according to the present invention.

FIG. 2 is a diagram illustrating the components of the pneumatic motor control system as secured to a pneumatic motor.

FIG. 3a is a block diagram illustrating the pneumatic motor control system according to a first embodiment.

FIG. 3b is a block diagram illustrating the pneumatic motor control system according to a second embodiment.

FIG. 4 is a block diagram illustrating a pneumatic motor control system according to a third embodiment.

### DETAILED DESCRIPTION OF THE PREFERRED EMBODIMENTS

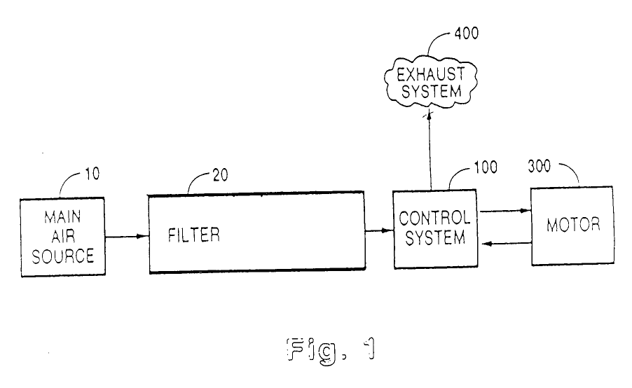

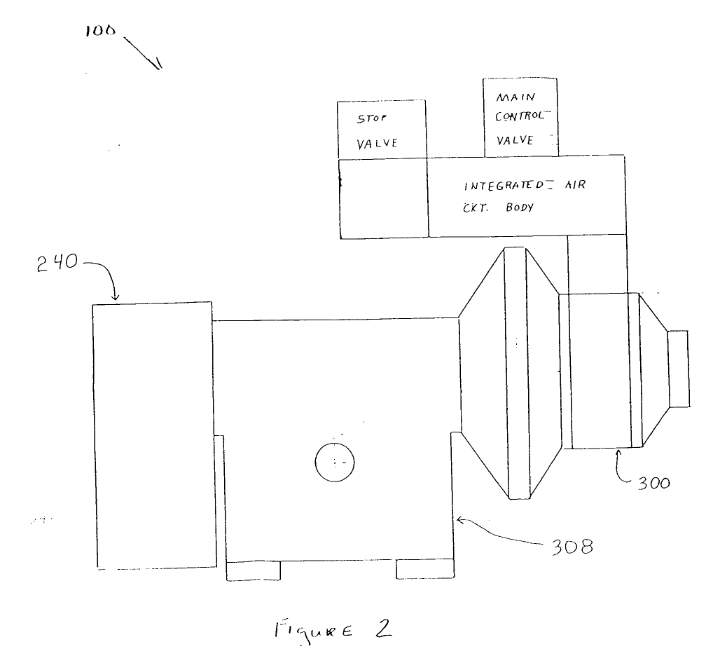

As illustrated in FIGS. 1 and 2, a pneumatic motor control system 100 mounts on a pneumatic motor 300 using any suitable means, such as bolts, to control the operation of the pneumatic motor 300. A first or main gas source 10 supplies gas that passes through a filter-regulator-lubricator 20 en route to the control system 100. Although in the preferred embodiments one gas source 10 is utilized, multiple gas sources may be used. Furthermore, the gas in the preferred embodiments is air; nevertheless, gases other than air may be used. The filter-regulator-lubricator 20 filters the gas, regulates the pressure, and adds oil that lubricates the valves of the control system 100. The filter-regulator-lubricator 20 removes particles and moisture that may cause the valves of the control system 100 to stick. The gas enters the control system 100 to initiate and then power the motor 300, which utilizes a gearbox 308 to drive an end use device. An end use device in the preferred embodiments is any device suitable for driving by the motor 300, which includes construction machinery, conveyors, hoisting equipment, mixing equipment, packaging equipment, paint/finishing equipment, printing equipment, pump drives, fan drives, and the like.

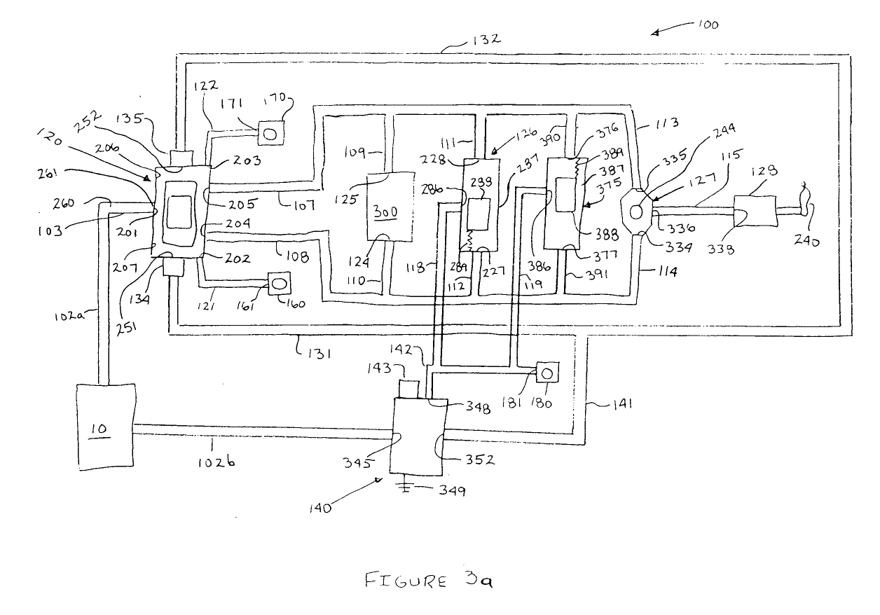

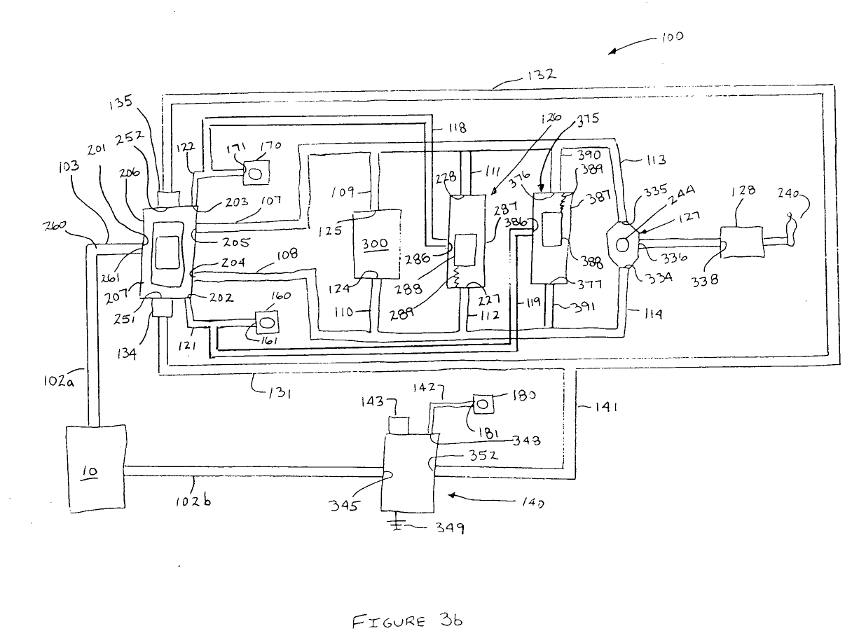

As illustrated in FIG. 3a, a first embodiment of the pneumatic motor control system 100 includes a first pilot valve 120 that initiates and then powers the motor 300 in either forward or reverse and a second pilot valve 140 that stops the motor 300. The control system 100 as shown in FIG. 3a may further include a third pilot valve 126 and a fourth pilot valve 375 that stop the motor 300 responsive to the end use device encountering an obstruction. The pilot valves are available from any suitable valve manufacturer. The first pilot valve 120 in the first embodiment may be a two position, double differential pilot valve with no springs. As such, the first pilot valve 120 will stay in a shifted position until forcibly returned to a neutral or centered position. The second pilot valve 140 in the second embodiment may be a two position, double differential pilot valve with no springs. The third pilot valve 126 and the fourth pilot valve 375 may be a pressure pilot valve. While the pneumatic motor control system 100 according to the first embodiment includes a motor reverse and a motor stop responsive to an end use device encountering an obstruction, those of ordinary skill in the art will recognize that in a simplest application only a motor forward and a motor stop are necessary.

The control system 100 further includes a first return gas cylinder 134, a second return gas cylinder 135, a shuttle check valve 127, and a brake gas cylinder 128. The first return gas cylinder 134 is coupled to the first pilot valve 120, such that it recenters a piston in the first pilot valve 120 from a first or start position associated with initiating forward operation of the motor 300. Likewise, the second return gas cylinder 135 is coupled to the first pilot valve 120, such that it recenters a piston in the first pilot valve 120 from a second or reverse position associated with initiating reverse operation of the motor 300. The shuttle check valve 127 automatically selects the highest pressure side to facilitate either forward or reverse operation of the motor 300. The brake gas cylinder 128 is used to release a brake 240 in the gearbox 308 of the motor 300.

The control system 100 still further includes a start button 160, a reverse button 170, and a stop button 180. The start button 160, the reverse button 170, and the stop button 180 in the first embodiment are manually opened check valves. In a normal state, the pneumatic control system 100 is pressurized. A continuously pressurized control system 100 allows for multiple activation buttons on a single pilot valve, and remote activation through an extended line. Once a button is activated, that particular side of a pilot valve is vented, thereby creating a pressure differential within the pilot valve. As a result, a piston in the pilot valve shifts from the higher pressure side to the lower pressure side, thereby aligning passages to alternate pressure lines. The buttons, either remotely or mounted to the pilot valves, are used to start and stop the motor 300 in the operation of an end use device.

In the first embodiment, the first pilot valve 120 includes an inlet port 201, a first piston port 202, a second piston port 203, a first outlet port 204, a second outlet port 205, a first exhaust port 206, and a second exhaust port 207. The first pilot valve 120 further includes a piston with first, second, third, and fourth passages. The first passage connects the inlet port 201 with the first outlet port 204 and the second passage connects the second outlet port 205 with the first exhaust port 206 when the piston shifts to the first or start position. Conversely, the third passage connects the inlet port 201 with the second outlet port 205 and the fourth passage connects the first outlet port 204 with the second exhaust port 207 when the piston shifts to the second or reverse position.

The main gas source 10 connects to line 102a, which, in turn, branches off to a first end 260 of a line 103. A second end 261 of the line 103 connects to the inlet port 201 of the first pilot valve 120. The start button 160 connects to the first piston port 202 via a line 121 that connects either remotely or directly to an inlet port 161 of the start button 160. Although not shown, the start button 160 connects to the main gas source 10 in order to maintain a pressure on the piston of the first pilot valve 120. The reverse button 170 connects to the second piston port 203 via a line 122 that connects either remotely or directly to an inlet port 171 of the start button 170. Although not shown, the start button 170 connects to the main gas source 10 in order to maintain a pressure on the piston of the first pilot valve 120.

The first gas cylinder 134 attaches to a first end 251 of a valve bore for the first pilot valve 120 such that the piston in the valve 120 returns from the first or start position to the neutral position when the first gas cylinder 134 is pressurized. The first gas cylinder 134 is coupled with the second pilot valve 140 via a line 131. The second gas cylinder 135 attaches to a second end 252 of a valve bore for the first pilot valve 120 such that the piston in the valve 120 returns from the second or reverse position to the neutral position when the second gas cylinder 135 is pressurized. The second gas cylinder 135 is coupled with the second pilot valve 140 via a line 132.

A line 108 connects to the first outlet port 204 of the first pilot valve 120. The line 108 branches into a line 110, which connects to a first port 124 of the motor 300. A line 107 connects to the second outlet port 205 of the first pilot valve 120. The line 107 branches into a line 109 that connects to a second port 125 of the motor 300. The line 108 connects to a line 114, which, in turn, connects to a first inlet port 334 of the shuttle check valve 127. The line 107 connects to a line 113, which, in turn, connects to a second inlet port 335 of the shuttle check valve 127. The shuttle check valve 127 includes a shuttle 244 that moves away from a higher pressure. A line 115 connects to an outlet port of the shuttle check valve 127. The line 115 further connects to an inlet port 338 of the brake gas cylinder 128. The brake gas cylinder 128 is coupled to the brake 240. In the first embodiment, the first port 124 and the second port 125 are both used as an inlet and an outlet for gas, depending on the desired direction of rotation of the vanes in the motor 300.

The third pilot valve 126 includes a first chamber port 227, a second chamber port 228, an inlet port 286, an outlet port 287, a piston 288, and a spring 289. The line 108 branches into a line 112, which, in turn, connects to the first chamber port 227 of the third pilot valve 126. The line 107 branches into a line 111 that connects to the second chamber port 228 of the third pilot valve 126. The inlet port 286 is coupled with the second pilot valve 140 via a line 118, and the outlet port 287 vents to the atmosphere. The piston 288, which includes a passage, connects to the spring 289.

The fourth pilot valve 375 includes a first chamber port 376, a second chamber port 377, an inlet port 386, an outlet port 387, a piston 388, and a spring 389. The line 107 branches into a line 390, which, in turn, connects to the first chamber port 376 of the fourth pilot valve 375. The line 108 branches into a line 391 that connects to the second chamber port 377 of the fourth pilot valve 375. The inlet port 386 is coupled with the second pilot valve 140 via a line 119, and the outlet port 387 vents to the atmosphere. The piston 388, which includes a passage, connects to the spring 389.

The second pilot valve 140 includes an inlet port 345, an outlet port 352, a piston port 348, a return gas cylinder 143 in alignment with a bore, and a mechanical stop 349. The second pilot valve 140 further includes a piston with a passage that connects the first inlet port 345 with the first outlet port 352 when the piston shifts to the stop position. The main gas source 10 connects to line 102b, which, in turn, connects to the first inlet port 345. The stop button 180 connects to the piston port 288 via a line 142 that connects either remotely or directly to an inlet port 181 of the stop button 180. Although not shown, the stop button 180 connects to the main gas source 10 in order to maintain a pressure on the piston of the second pilot valve 140. In addition, the line 118 connects with the line 142 to couple the inlet port 286 of the third pilot valve 126 with the piston port 288 of the second pilot valve 140. Similarly, the line 119 connects with the line 142 to couple the inlet port 386 of the fourth pilot valve 375 with the piston port 288 of the second pilot valve 140. Still further, the line 141 branches into a line 131, which, in turn, connects to the first gas cylinder 134, thereby connecting the first gas cylinder 134 with the outlet port 352 of the second pilot valve 140. Similarly, the line 141 branches into a line 132, which, in turn, connects to the second gas cylinder 135, thereby connecting the second gas cylinder 135 with the outlet port 352 of the second pilot valve 140.

In operation, the control system 100 is continuously pressurized, and is capable of starting, stopping, and reversing the motor 300. The control system 100 is further capable of stopping the motor 300 when the end use device encounters an obstruction. When the control system 100 is in an equilibrium state and the motor 300 is stopped, the main gas source 10 pressurizes the lines 102a and 102b and thus the line 103. The line 103 terminates at the inlet port 201 of the first pilot valve 120. In a non-biased condition, the piston of the first pilot valve 120 is located in the center of the bore. As there are no passages in the center of the piston, no gas passes through the piston to either the outlet port 204 or the outlet port 205.

However, when the start button 160 is pressed, the end of the valve bore adjacent to the start button 160 loses pressure due to the venting by the start button 160. The resulting pressure differential forces the piston to the end of the bore nearest the start button 160, which is the first or start position. In the first or start position, the first passage in the piston lines up with the inlet port 201 and the first outlet port 204 to allow gas into the line 108, which, in turn, pressurizes the lines 110, 109, 107, 111, 390, and 113. Gas in the line 113 pressurizes the second inlet port 335 of the shuttle check valve 127, thereby forcing the shuttle 244 to block the first inlet port 334 of the shuttle check valve 127. The shuttle check valve 127 then builds pressure to further increase the flow of gas through the motor 300. As the gas pressure builds in the shuttle check valve 127, gas is able to exit the shuttle check valve 127 through the outlet port 336, thereby entering line 115 and pressurizing the brake gas cylinder 128. Pressurizing the brake gas cylinder 128 releases the brake 240 in the gearbox 308 of the motor 300 so that the motor 300 components are able to rotate when gas flows through the motor 300. The brake 240 is normally spring loaded in the engaged position.

Gas in the line 110 enters the first port 124 of the motor 300 and forces the vanes to rotate, thereby rotating the motor driveshaft and driving the end use device. The gas passing through the motor 300 exits the second port 125 of the motor 300 and pressurizes the line 107. In the first or start position, the second passage in the piston lines up with the second outlet port 205 and the first exhaust port 206. Consequently, the gas within the line 107 enters the first pilot valve 120 at the second outlet port 205 and exits the first pilot valve 120 to atmosphere via the first exhaust port 206. As such, the gas passing through the motor 300 is unrestricted and the motor 300 will continue to drive the end use device until the stop button 180 is pressed.

Conversely, when the reverse button 170 is pressed, the end of the valve bore adjacent to the reverse button 170 loses pressure due to the venting by the reverse button 170. The resulting pressure differential forces the piston to the end of the bore nearest the reverse button 170, which is the second or reverse position. In the second or reverse position, the third passage in the piston lines up with the inlet port 201 and the second outlet port 205 to allow gas into the line 107, which, in turn, pressurizes the lines 109, 110, 108, 112, 391, and 114. Gas in the line 114 pressurizes the first inlet port 334 of the shuttle check valve 127, thereby forcing the shuttle 244 to block the second inlet port 335 of the shuttle check valve 127. The shuttle check valve 127 then builds pressure to further increase the flow of gas through the motor 300. As the gas pressure builds in the shuttle check valve 127, gas is able to exit the shuttle check valve 127 through the outlet port 336, thereby entering line 115 and pressurizing the brake gas cylinder 128. Pressurizing the brake gas cylinder 128 releases the brake 240 in the gearbox 308 of the motor 300 so that the motor 300 components are able to rotate when gas flows through the motor 300. The brake 240 is normally spring loaded in the engaged position.

Gas in the line 109 enters the second port 125 of the motor 300 and forces the vanes to rotate, thereby rotating the motor driveshaft and driving the end use device. The gas passing through the motor 300 exits the first port 124 of the motor 300 and pressurizes the line 108. In the second or reverse position, the fourth passage in the piston lines up with the first outlet port 204 and the second exhaust port 207. Consequently, the gas within the line 108 enters the first pilot valve 120 at the first outlet port 204 and exits the first pilot valve 120 to atmosphere via the second exhaust port 207. As such, the gas passing through the motor 300 is unrestricted and the motor 300 will continue to drive the end use device in reverse until the stop button 180 is pressed.

Upon pressing the stop button 180, the control system 100 stops the motor 300. Normally, the line 102b is constantly pressurized by the main gas source 10, and the piston of the second pilot valve 140 resides in a neutral position. In the neutral position, the piston does not allow the gas to pass from the first inlet port 345 to the first outlet port 352. However, when the stop button 180 is pressed, the piston moves toward the stop button 180 due to the pressure differential in the bore. Once shifted, the piston allows the gas to flow from the first inlet port 345 to the first outlet port 352, thereby pressurizing the line 141. The line 141 delivers gas into the line 131, which, in turn delivers gas into the first return gas cylinder 134. Likewise, the line 141 delivers gas into the line 132, which, in turn delivers gas into the second return gas cylinder 135. Pressurizing the first and second return gas cylinders 134 and 135 extends the first and second return gas cylinders 134 and 135, thereby centering the piston of the first pilot valve 120 and stopping gas flow to the motor 300. Extending both the first and second return gas cylinders 134 and 135 stops the motor 300 regardless of whether the motor 300 is operating in forward or reverse. After centering the piston, the first and second return gas cylinders 134 and 135 retract using gas delivered to the first and second return gas cylinders 134 and 135 or a spring disposed in the first and second return gas cylinders 134 and 135. Once the motor 300 stops, compressed gas is allowed behind the piston in the return gas cylinder 143, which causes the return gas cylinder 143 to extend. Upon extending, the return gas cylinder 143 forces the piston of the second pilot valve 140 to return to a centered position. The stop 349 prevents the piston from moving past the centered position. After centering the piston, the return gas cylinders 143 retracts using gas delivered to the return gas cylinders 143 or a spring disposed in the return gas cylinders 143.

The control system 100 may include the third pilot valve 126 to stop the motor 300 if the end use device encounters an obstruction during forward operation. In operation, the pressures experienced in the lines 111 and 112 directly reflect the pressures in the ends of the passage in the third pilot valve 126. If the motor 300 is receiving gas from the gas source 10, then there is an imbalance between the two sides of the third pilot valve 126. In the normal position, the piston 288 of the third pilot valve 126 is situated such that it is free to move in the third pilot valve 126. The piston 288 nevertheless is connected to a biasing mechanism, which in the first embodiment is a spring 289. In use, the pressure differential must overcome the spring 289 force to move the piston 288 towards the first chamber port 227.

As the control system 100 operates the motor 300, gas is pressurizing the lines 108, 110, 109, 107, and 111, thereby creating an imbalance situation in the third pilot valve 126. The increased pressure in the line 111 forces the piston in the third pilot valve 126 to move toward the first chamber port 227. The distance moved can be ascertained by knowing the spring rate of the spring 289, the area of the piston 288, and the pressure differential between the two sides of the third pilot valve 126. Movement to compress the spring 289 is acceptable; however, extreme differential pressures will cause the spring 289 to compress to a point where the passage in the piston 288 aligns with the inlet port 286 and the outlet port 287. Extreme pressure differentials are experienced when the end use device encounters an obstruction, as the compressed gas experiences a resistance due to the mechanical resistance experienced by the end use device. Alignment of the passage with the inlet port 286 and the outlet port 287 allows the pressure in the line 118 and thus the pressure in the line 142 to drop, thereby activating the stop sequence of the control system 100 as previously described.

The control system 100 may include the fourth pilot valve 375 to stop the motor 300 if the end use device encounters an obstruction during reverse operation. In operation, the pressures experienced in the lines 390 and 391 directly reflect the pressures in the ends of the passage in the fourth pilot valve 375. If the motor 300 is receiving gas from the gas source 10, then there is an imbalance between the two sides of the fourth pilot valve 375. In the normal position, the piston 388 of the fourth pilot valve 375 is situated such that it is free to move in the fourth pilot valve 375. The piston 388 nevertheless is connected to a biasing mechanism, which in the first embodiment is a spring 389. In use, the pressure differential must overcome the spring 389 force to move the piston 388 towards the first chamber port 376.

As the control system 100 operates the motor 300 in reverse, gas is pressurizing the lines 107, 109, 110, 108, and 391, thereby creating an imbalance situation in the fourth pilot valve 375. The increased pressure in the line 391 forces the piston in the fourth pilot valve 375 to move toward the first chamber port 376. The distance moved can be ascertained by knowing the spring rate of the spring 389, the area of the piston 388, and the pressure differential between the two sides of the fourth pilot valve 375. Movement to compress the spring 389 is acceptable; however, extreme differential pressures will cause the spring 389 to compress to a point where the passage in the piston 388 aligns with the inlet port 386 and the outlet port 387. Extreme pressure differentials are experienced when the end use device encounters an obstruction, as the compressed gas experiences a resistance due to the mechanical resistance experienced by the end use device. Alignment of the passage with the inlet port 386 and the outlet port 387 allows the pressure in the line 113 and thus the pressure in the line 142 to drop, thereby activating the stop sequence of the control system 100 as previously described.

As illustrated in FIG. 3b, a second embodiment of the pneumatic motor control system 100 includes the capability to changing the direction of the motor 300 responsive to the end use device encountering an obstruction. The operations of the second embodiment of the pneumatic motor control system 100 in starting the motor 300, reversing the motor 300, and stopping the motor 300 are identical to those of the first embodiment. Consequently, those operations will not be described, and like parts have been referenced with like numerals. However, in the second embodiment of the pneumatic motor control system 100, the line 118 connects to the line 122, and the line 119 connects to the line 121. Consequently, when an end use device encounters an obstruction during forward operation, the third pilot valve 126 vents the line 122, thereby facilitating reverse operation of the motor 300 as previously described. Likewise, when an end use device encounters an obstruction during reverse operation, the fourth pilot valve 375 vents the line 121, thereby facilitating forward operation of the motor 300 as previously described.

The pneumatic motor control system 100 may further include a forward or open limit trigger and a reverse or close limit trigger as described in U.S. patent application Ser. No. 10/930,658. A forward or open limit trigger and a reverse or close limit trigger would connect to the main gas source 10, the second pilot valve 140, and the first and second return gas cylinders 134 and 135 identically to that described in U.S. patent application Ser. No. 10/930,658. Moreover, the pneumatic motor control system 100 may include a manual override circuit identical to that described in U.S. patent application Ser. No. 10/930,658.

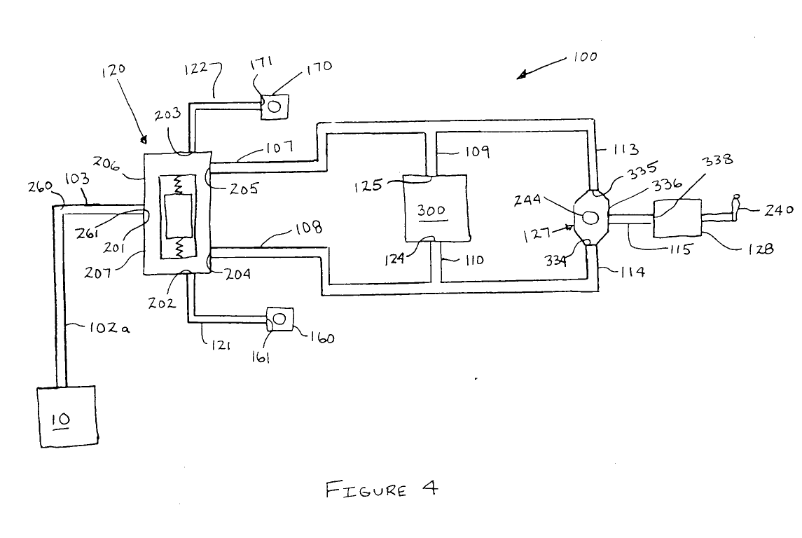

As illustrated in FIG. 4, a third embodiment of the pneumatic motor control system 100 includes a feature whereby a user must continuously operate the control system 100 in order to power an end use device. The third embodiment is identical to the first and second embodiments and like parts have been referenced with like numerals, except the first pilot valve 120 includes return springs attached to the piston of the first pilot valve 120. As such, the piston of the first pilot valve remains in a neutral or centered position unless forcibly shifted. Moreover, the third embodiment does not require stop or reverse features due to the requirement for continuous operation of the control system 100.

In operation, a user must press and hold the start button 160 to facilitate forward operation of the motor 300. Pressing and holding the start button 160 vents the end of the valve bore adjacent to the start button 160 resulting in the piston traveling to the end of the bore nearest the start button 160. This commences operation of the motor 300, and, as long as the start button 160 remains depressed, the control system 100 delivers gas to the motor 300 and forward operation of the motor 300 occurs as previously described. However, upon release of the start button 160, the return springs in the first valve 120 return the piston to the neutral or centered position, thereby stopping gas flow to the motor 300, which ceases forward operation of the motor 300.

Conversely, a user must press and hold the reverse button 170 to facilitate reverse operation of the motor 300. Pressing and holding the reverse button 170 vents the end of the valve bore adjacent to the reverse button 170 resulting in the piston traveling to the end of the bore nearest the reverse button 170. This commences operation of the motor 300, and, as long as the reverse button 170 remains depressed, the control system 100 delivers gas to the motor 300 and reverse operation of the motor 300 occurs as previously described. However, upon release of the reverse button 170, the return springs in the first valve 120 return the piston to the neutral or centered position, thereby stopping gas flow to the motor 300, which ceases reverse operation of the motor 300.

Although the present invention has been described in terms of the foregoing preferred embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

We claim:

1. A pneumatic motor control system, comprising:
a pneumatic gas source;
a pneumatic motor;
a first pilot valve in communication between the pneumatic gas source and the pneumatic motor, wherein the first pilot valve rests in a neutral position that does not allow the passage of gas from the pneumatic gas source to the pneumatic motor; and
a first pressurized check valve in communication with the first pilot valve, wherein venting of the first pressurized check valve shifts the first pilot valve to a first position that allows the passage of gas from the pneumatic gas source through the first pilot valve and through the pneumatic motor from a first port of the pneumatic motor to a second port of the pneumatic motor.

2. The pneumatic motor control system according to claim 1, wherein, in the first position, the first pilot valve exhausts gas leaving the second port of the pneumatic motor.

3. The pneumatic motor control system according to claim 1, comprising:
a first return gas cylinder coupled to the first pilot valve;
a second pilot valve in communication between the pneumatic gas source and the first return gas cylinder, wherein the second pilot valve rests in a neutral position that does not allow the passage of gas from the pneumatic gas source to the first return gas cylinder; and
a pressurized check valve in communication with the second pilot valve, wherein venting of the pressurized check valve shifts the second pilot valve to a first position that allows the passage of gas from the pneumatic gas source through the second pilot valve and to the first return gas cylinder.

4. The pneumatic motor control system according to claim 3, wherein pressurizing the first return gas cylinder extends the first return gas cylinder, thereby returning the first pilot valve from the first position to the neutral position.

5. The pneumatic motor control system according to claim 1, wherein ceasing the venting of the first pressurized check valve in communication with the first pilot valve returns the first pilot valve from the first position to the neutral position.

6. The pneumatic motor control system according to claim 1, wherein the first pilot valve includes a biasing return that maintains the first pilot valve in the neutral position when the system is not vented.

7. The pneumatic motor control system according to claim 1, further comprising:
a brake gas cylinder coupled to a brake; and
a shuttle check valve in communication with the first and second ports of the pneumatic motor and the brake gas cylinder, wherein delivery of gas to the pneumatic motor opens the shuttle check valve to the brake gas cylinder, thereby extending the brake gas cylinder to release the brake.

8. The pneumatic motor control system according to claim 7, wherein the brake is in communication with a driveshaft of the pneumatic motor to prevent rotation of the driveshaft in an unpressurized state.

9. The pneumatic motor control system according to claim 3, further comprising:
a third pilot valve in communication with the first and second ports of the pneumatic motor and the pressurized check valve in communication with the second pilot valve; and
a biasing mechanism disposed in the third pilot valve, wherein, when a pressure differential between the first and second ports of the pneumatic motor overcomes the biasing force of the biasing mechanism, the third pilot valve vents the pressurized check valve in communication with the second pilot valve, thereby shifting the second pilot valve to the first position and allowing the passage of gas from the pneumatic gas source through the second pilot valve and to the first return gas cylinder.

10. The pneumatic motor control system according to claim 11, wherein pressurizing the first return gas cylinder extends the return gas cylinder, thereby returning the first pilot valve from the first position to the neutral position.

11. The pneumatic motor control system according to claim 1, further comprising a second pressurized check valve in communication with the first pilot valve, wherein venting of the second check valve shifts the first pilot valve to a second position that allows the passage of gas from the pneumatic gas source through the first pilot valve and through the pneumatic motor from the second port of the pneumatic motor to the first port of the pneumatic motor.

12. The pneumatic motor control system according to claim 11, wherein, in the second position, the first pilot valve exhausts gas leaving the first port of the pneumatic motor.

13. The pneumatic motor control system according to claim 11, comprising:
a first return gas cylinder coupled to the first pilot valve;
a second return gas cylinder coupled to the first pilot valve;
a second pilot valve in communication between the pneumatic gas source and the first and second return gas cylinders, wherein the second pilot valve rests in a neutral position that does not allow the passage of gas from the pneumatic gas source to the first and second return gas cylinders; and
a pressurized check valve in communication with the second pilot valve, wherein venting of the check valve shifts the second pilot valve to a first position that allows the passage of gas from the pneumatic gas source through the second pilot valve and to the first and second return gas cylinders.

14. The pneumatic motor control system according to claim 13, wherein pressurizing the first and second return gas cylinders extends the first and second return gas cylinders, thereby returning the first pilot valve from either the first position or the second position to the neutral position.

15. The pneumatic motor control system according to claim 11, wherein ceasing the venting of the second pressurized check valve in communication with the first pilot valve returns the first pilot valve from the second position to the neutral position.

16. The pneumatic motor control system according to claim 11, wherein the first pilot valve includes a biasing return that maintains the first pilot valve in the neutral position when the system is not vented.

17. The pneumatic motor control system according to claim 13, further comprising:
a third pilot valve in communication with the first and second ports of the pneumatic motor and the pressurized check valve in communication with the second pilot valve; and
a biasing mechanism disposed in the third pilot valve, wherein, when a pressure differential between the first and second ports of the pneumatic motor overcomes the biasing force of the biasing mechanism, the third pilot valve vents the pressurized check valve in communication with the second pilot valve, thereby shifting the second pilot valve to the first position and allowing the passage of gas from the pneumatic gas source through the second pilot valve and to the first and second return gas cylinders.

18. The pneumatic motor control system according to claim 17, wherein pressurizing the first and second return gas cylinders extends the first and second return gas cylinders, thereby returning the first pilot valve from either the first position or the second position to the neutral position.

19. The pneumatic motor control system according to claim 17, further comprising:
a fourth pilot valve in communication with the first and second ports of the pneumatic motor and the pressurized check valve in communication with the second pilot valve; and
a biasing mechanism disposed in the fourth pilot valve, wherein, when a pressure differential between the first and second ports of the pneumatic motor overcomes the biasing force of the biasing mechanism, the fourth pilot valve vents the pressurized check valve in communication with the second pilot valve, thereby shifting the second pilot valve to the first position and allowing the passage of gas from the pneumatic gas source through the second pilot valve and to the first and second return gas cylinders.

20. The pneumatic motor control system according to claim 19, wherein pressurizing the first and second return gas cylinders extends the first and second return gas cylinders, thereby returning the first pilot valve from either the first position or the second position to the neutral position.

21. The pneumatic motor control system according to claim 11, further comprising:
a third pilot valve in communication with the first and second ports of the pneumatic motor and the second pressurized check valve in communication with the first pilot valve; and
a biasing mechanism disposed in the third pilot valve, wherein, when a pressure differential between the first and second ports of the pneumatic motor overcomes the biasing force of the biasing mechanism, the third pilot valve vents the second pressurized check valve in communication with the first pilot valve, thereby allowing the passage of gas from the pneumatic gas source through the first pilot valve and through the pneumatic motor from the second port of the pneumatic motor to the first port of the pneumatic motor.

22. The pneumatic motor control system according to claim 21, further comprising:
a fourth pilot valve in communication with the first and second ports of the pneumatic motor and the first pressurized check valve in communication with the first pilot valve; and
a biasing mechanism disposed in the fourth pilot valve, wherein, when a pressure differential between the first and second ports of the pneumatic motor overcomes the biasing force of the biasing mechanism, the fourth pilot valve vents the first pressurized check valve in communication with the first pilot valve, thereby allowing the passage of gas from the pneumatic gas source through the first pilot valve and through the pneumatic motor from the first port of the pneumatic motor to the second port of the pneumatic motor.

23. A method of controlling a pneumatic motor, comprising:
venting a first pressurized check valve in communication with a first pilot valve, thereby moving the first pilot valve from a neutral position to a first position; and
delivering gas from a pneumatic gas source through the first pilot valve and through the pneumatic motor from a first port of the pneumatic motor to a second port of the pneumatic motor.

24. The method of controlling a pneumatic motor according to claim 23, further comprising exhausting via the first pilot valve gas leaving the second port of the pneumatic motor.

25. The method of controlling a pneumatic motor according to claim 23, further comprising:
venting a pressurized check valve in communication with a second pilot valve, thereby moving the second pilot valve from a neutral position to a first position; and
delivering gas from the pneumatic gas source through the second pilot valve and to a first return gas cylinder, thereby extending the first return gas cylinder to shift the first pilot valve from the first position to the a neutral position.

26. The method of controlling a pneumatic motor according to claim 23, further comprising ceasing the venting of the first pressurized check valve in communication with the first pilot valve to return the first pilot valve from the first position to the neutral position.

27. The method of controlling a pneumatic motor according to claim 25, further comprising:
measuring the pressure differential between the first and second ports of the pneumatic motor;
venting the pressurized check valve in communication with the second pilot valve, thereby moving the second pilot valve from the neutral position to the first position when the pressure differential between the first and second ports of the pneumatic motor surpasses a desired level; and
delivering gas from the pneumatic gas source through the second pilot valve and to a first return gas cylinder, thereby extending the first return gas cylinder to shift the first pilot valve from the first position to the neutral position.

28. The method of controlling a pneumatic motor according to claim 23, further comprising:
venting a second pressurized check valve in communication with the first pilot valve, thereby moving the first pilot valve from the neutral position to a second position; and
delivering gas from a pneumatic gas source through the first pilot valve and through the pneumatic motor from the second port of the pneumatic motor to the first port of the pneumatic motor.

29. The method of controlling a pneumatic motor according to claim 28, further comprising exhausting via the first pilot valve gas leaving the first port of the pneumatic motor.

30. The method of controlling a pneumatic motor according to claim 28, further comprising:
venting a pressurized check valve in communication with a second pilot valve, thereby moving the second pilot valve from a neutral position to a first position; and
delivering gas from the pneumatic gas source through the second pilot valve and to first and second return gas cylinders, thereby extending the first and second return gas cylinders to shift the first pilot valve from either the first position or the second position to the neutral position.

31. The method of controlling a pneumatic motor according to claim 28, further comprising ceasing the venting of the second pressurized check valve in communication with the first pilot valve to return the first pilot valve from the second position to the neutral position.

32. The method of controlling a pneumatic motor according to claim 30, further comprising:
measuring the pressure differential between the first and second ports of the pneumatic motor;
venting the pressurized check valve in communication with the second pilot valve, thereby moving the second pilot valve from the neutral position to the first position when the pressure differential between the first and second ports of the pneumatic motor surpasses a desired level; and
delivering gas from the pneumatic gas source through the second pilot valve and to first and second return gas cylinders, thereby extending the first and second return gas cylinders to shift the first pilot valve from either the first position or the second position to the neutral position.

33. The method of controlling a pneumatic motor according to claim 28, further comprising:
measuring the pressure differential between the first and second ports of the pneumatic motor;
venting the second pressurized check valve in communication with the first pilot valve when the pressure differential between the first and second ports of the pneumatic motor surpasses a desired level; and
delivering gas from a pneumatic gas source through the first pilot valve and through the pneumatic motor from the second port of the pneumatic motor to the first port of the pneumatic motor.

34. The method of controlling a pneumatic motor according to claim 33, further comprising:
measuring the pressure differential between the first and second ports of the pneumatic motor;
venting the first pressurized check valve in communication with the first pilot valve when the pressure differential between the first and second ports of the pneumatic motor surpasses a desired level; and
delivering gas from a pneumatic gas source through the first pilot valve and through the pneumatic motor from the first port of the pneumatic motor to the second port of the pneumatic motor.
